(19) United States
(12) Patent Application Publication
(10) Pub. No.: US 2004/0034983 A1
(43) Pub. Date: Feb. 26, 2004

(54) Method of fabricating a photo-frame

(76) Inventor: Tony Huang, Taipei (TW)

Correspondence Address: Tony HUANG, PO Box 82-144, TAIPEI, TW

(21) Appl. No.: 10/227,501

(22) Filed: Aug. 26, 2002

(51) Int. Cl. B23P 11/00

(52) U.S. Cl. 29/458

(57) ABSTRACT

A method of fabricating a photo-frame is disclosed. The method comprises a photo-frame into a shape with a plurality of external frame boards, together with a bottom board adhered to the bottom section of the external frame boards, and having a positioning center pole at the center of the frame; inserting a layering board to the bottom of the pole body and adhering with the bottom board; mixing homogeneously a mixture of sand and a glue for filling the mixed sand to a space formed by the photo-frame; adhering an immediate board and a design board in sequence onto the layering board; conducting a sand filing step so that the surface of the sand is in alignment with the external frame board, removing the center pole upon curing of the sand and then removing in sequence the bottom board, the layering board, the design board and the internal board to form a photo frame.

### BACKGROUND OF THE INVENTION

(a) Technical Field of the Invention

The present invention relates to photo-frame structure, and in particular, a method of fabricating a photo-frame using sand particles and glue to form the main body of the photo-frame. This is a DIY method to form a photo-frame structure.

(b) Description of the Prior Art

Normally, photographs are kept either in photo-album or mounted in a photo frame for displaying. Common photo frames are sold and are made from acrylic or plastic material, or wood, and these materials are not trendy. One type of DIY photo frame is that a plurality of parts are provided and are used to form into a frame. However, the raw material for making the frame is very limited and the photo frame thus obtained is more or less similar to those available in the market, and they do not provide a trendy or an esthetic appearance.

### SUMMARY OF THE INVENTION

Accordingly, it is an object of the present invention to provide a DIY method of fabricating a photo-frame having a frame body, a transparent film mounted thereto and an insertion support board, comprising the steps of forming a photo-frame into a shape with a plurality of external frame boards, together with a bottom board adhered to the bottom section of the external frame boards, and having a positioning center pole at the center of the frame; inserting a layering board to the bottom of the pole body and adhering with the bottom board; mixing homogeneously a mixture of sand and a glue for filling the mixed sand to a space formed by the photo-frame; adhering an immediate board and a design board in sequence onto the layering board; conducting a sand filing step so that the surface of the sand is in alignment with the external frame board, removing the center pole upon curing of the sand and then removing in sequence the bottom board, the layering board, the design board and the internal board to form a photo frame.

Yet another object of the present invention is to provide a method of fabricating a photo-frame a plurality of the external frame boards are prefabricated so as to form onto a desired shape of photo frame.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a mold structure for the fabrication of a photo frame in accordance with the present invention

FIG. 2 is a perspective view showing sand particles being filled into the mold structure of the present invention.

FIGS. 3A and 3B are a sectional views showing sand particles being filled into the mold structure of the present invention.

FIG. 4 is a schematic perspective view showing the combination of components of the photo frame in accordance with the present invention.

FIG. 5 and FIG. 6 are perspective view of the photo frame in accordance with the present in invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

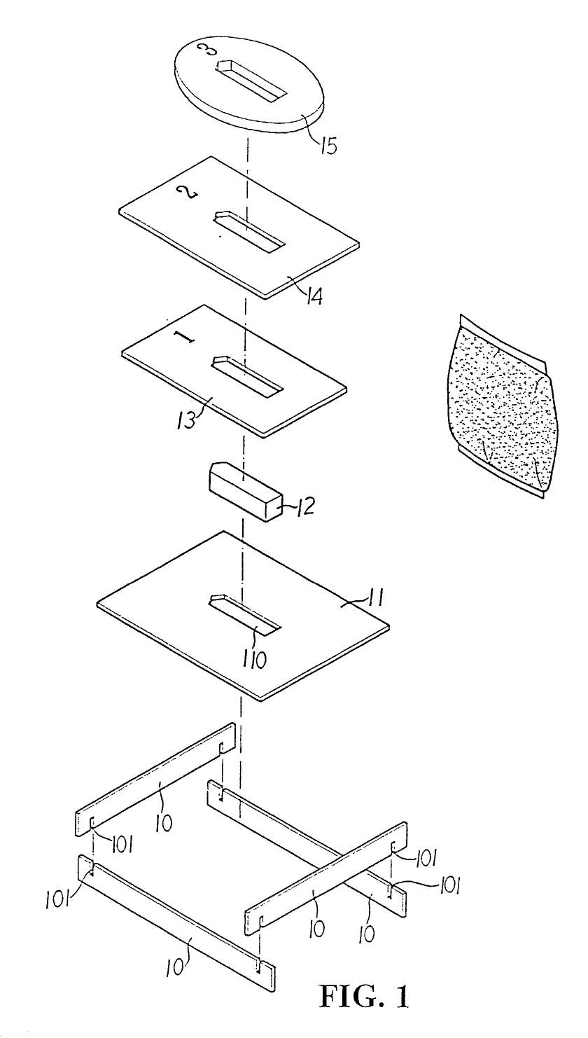

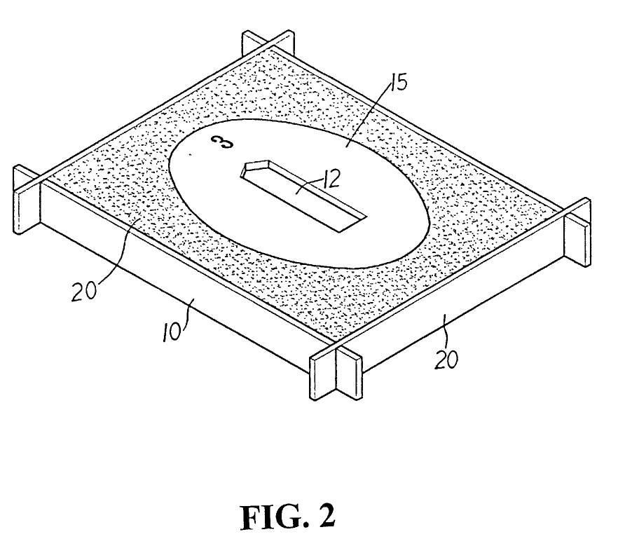

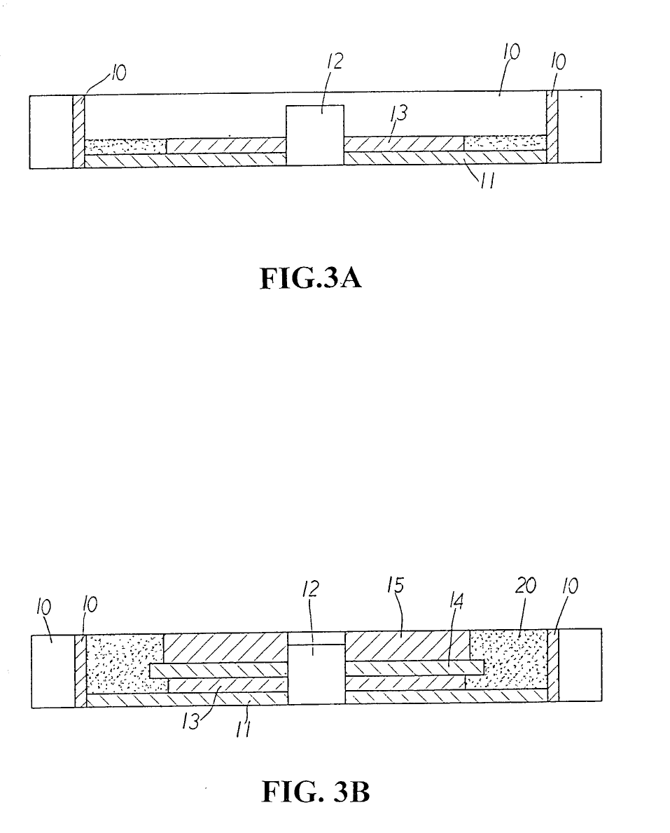

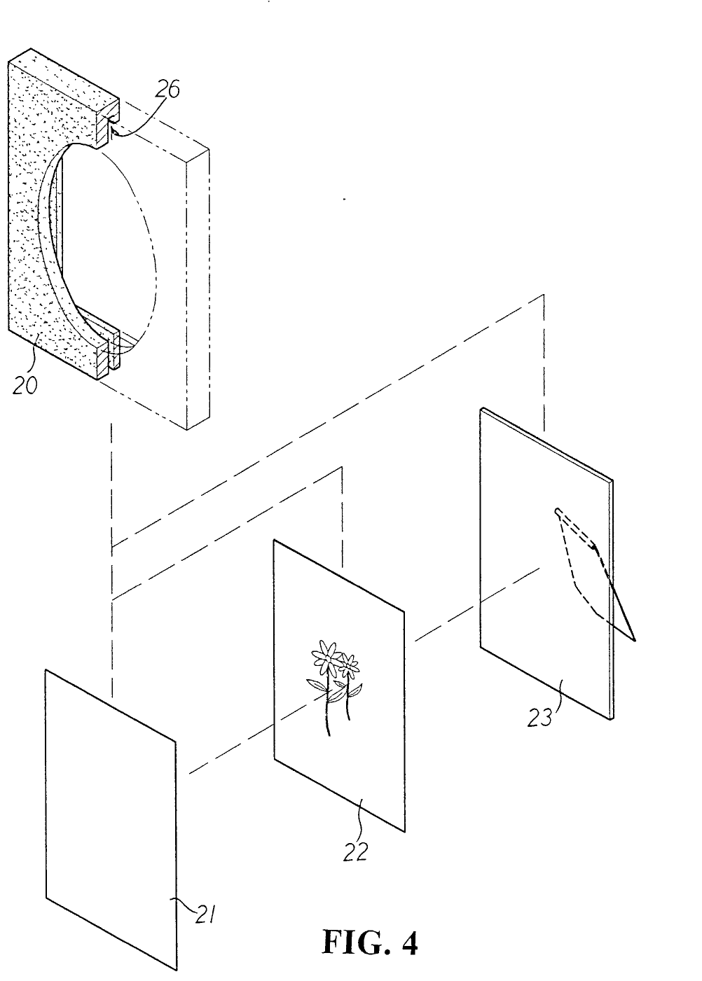

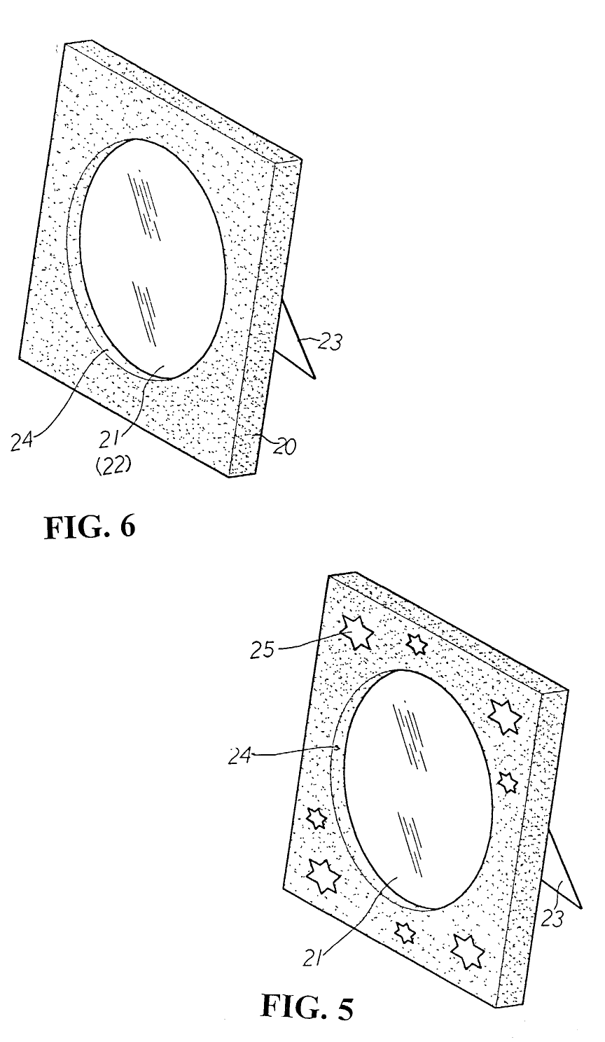

Referring to FIGS. 1 to 6, there is shown a DIY method of fabricating a photo-frame structure having a rectangular, square or oval shape. The desired shape of the photo-frame structure includes a plurality of easily assemble external frame boards 10 to form the boundary of the frame body 20. Preferably, a special design can be made as an integral unit. In accordance with the present invention, the external frame board 10 is provided with corresponding recess 101 to engage with another recess 101 on another external frame board 10, forming into a photo frame structure boundary. A bottom board 11 is mounted onto the bottom section of the frame to form a reference surface. The size of the bottom board 11 is made so that it is mounted with the inner edge of the frame structure, or the size of the bottom board 11 is made into a larger surface wherein the external frame structure is formed on the board. The positioning of the mold module is by means of a center pole 12 directly inserted on a center hole 110 on the bottom board 11.

After that, layering board 13 is mounted onto the bottom board 11 so as to form into a bottom layer space of the photo frame body 20 and a homogeneous mixture of sand particles and adhesive in an appropriate proportion is then filled thereto. The space formed by the entire layering board 13 and the bottom bard 11 is fully filled. Then, an intermediate inner board 14 is adhered flatly onto the layering board 13 so that the wider board surface and the thicker board surface can be partitioned into a recessed space 26 to insert a transparent plate 21, a photograph 22 and an insertion board 23. The external edge of the inner board 14 is stacked to form a designing board 15 with a transparent window 24 of the photo frame 20. The design of the window 24 can be made into any design required by the designer. The height of the stacked boards is in aligned with that of the external frame board 10 to proceed with a second time of sand particle filling which is cured naturally.

The time required for curing is about a day depending on the ratio of the components of the mixture. To unload the photo frame, the center pole 12 is first withdrawn and the boards will become loose and in sequence, the bottom board 1, the layering board 13 and the designing board 15, the inner board 14 are unloaded. As a result, a complete photo frame body 20 made of sand particles is obtained.

In accordance with the present invention, the size of the sand particle is about 15 to 100 mesh number and the adhesive is a non-toxic edible glue. Preferably the ratio of sand particle to the adhesive is about 1:25 to 1:30.

In the present preferred embodiment, the surface of the photo frame can be provided with designs by engraving or adhering with the decorative objects such as shells, shining objects or jades.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A DIY method of fabricating a photo-frame having a frame body, a transparent film mounted thereto and an insertion support board, comprising the steps of:
(a) forming a photo-frame into a shape with a plurality of external frame boards, together with a bottom board adhered to the bottom section of the external frame boards, and having a positioning center pole at the center of the frame;
(b) inserting a layering board to the bottom of the pole body and adhering with the bottom board;
(c) mixing homogeneously a mixture of sand and a glue for filling the mixed sand to a space formed by the photo-frame;
(d) adhering an immediate board and a design board in sequence onto the layering board;
(e) conducting a sand filing step so that the surface of the sand is in alignment with the external frame board;
(f) removing the center pole upon curing of the sand and then removing in sequence the bottom board, the layering board, the design board and the internal board to form a photo frame.

2. The method of claim 1, wherein a plurality of the external frame boards are prefabricated so as to form into a desired shape of photo frame.

3. The method of claim 1, wherein the designing board is a prefabricated board.

4. The method of claim 1, wherein the size of sand particles is about 15 to 100 mesh number.

5. The method of claim 1, wherein the adhesive is a non-toxic but edible adhesive agent.

6. The method of claim 1, wherein the ratio of adhesive to the sand particle is ranging from 1:25 kg to 1:30 kg.

7. The method of claim 1, wherein the surface of the frame prior to curing is made into an aesthetic surface or is mounted with decorative objects.

8. The method of claim 7, wherein the decorative objects are selected from shells, shining platelets or jades.
